(19) United States
(12) Patent Application Publication
(10) Pub. No.: US 2026/0067227 A1
(43) Pub. Date: Mar. 5, 2026

(54) SERVICE PROVIDING SYSTEM, INFORMATION PROCESSING APPARATUS, AND SERVICE PROVIDING PROGRAM

(71) Applicant: KYOCERA DOCUMENT SOLUTIONS INC., OSAKA-SHI (JP)

(72) Inventors: KENTO YAMAMOTO, OSAKA-SHI (JP); KOSUKE HAMAZAKI, OSAKA-SHI (JP)

(21) Appl. No.: 19/313,805

(22) Filed: Aug. 28, 2025

(30) Foreign Application Priority Data
Aug. 29, 2024 (JP) 2024-147966
Aug. 29, 2024 (JP) 2024-147967

(51) Int. Cl. H04L 47/25; G06F 9/54

(52) U.S. Cl. CPC H04L 47/25; G06F 9/54

(57) ABSTRACT

A service providing system executes connection to a micro-service according to a specific request in a case where the service providing system has received the specific request, which is a specific application programming interface (API) request assigned specific identification information, and where the number of times of reception of the API request assigned the specific identification information has not exceeded a specific rate limit. The specific identification information is identification information of a specific client. The specific rate limit is a rate limit associated with the specific identification information. The service providing system updates the specific rate limit in accordance with a whole load of all the micro-services that operate in response to the specific request in a case where the service providing system has received the specific request.

### CROSS-REFERENCE TO RELATED PATENT APPLICATION

This application claims the benefit of Japanese Priority Patent Application JP 2024-147966 filed Aug. 29, 2024 and Japanese Priority Patent Application JP 2024-147967 filed Aug. 29, 2024, the entire contents of which are incorporated herein by reference.

### FIELD OF THE DISCLOSURE

The present disclosure relates to a service providing system, an information processing apparatus, and a service providing program that provide a service used by a user terminal used by a user.

### BACKGROUND OF THE DISCLOSURE

In the related art, a technology that recognizes a power user as a power user who submits application programming interface (API) events in excess of a limit when an API event rate or volume for a user group, overall, exceeds or approaches a SaaS vendor imposed trigger for imposition of throughput penalty on the user group, and rations transmittal of API event submissions from the power user to the SaaS vendor by assigning the power user to an auxiliary API event queue managed by a proxy that slows a rate of submission to the SaaS vendor by the power user is known (e.g., see Japanese Unexamined Patent Application Publication No. 2024-504201).

### SUMMARY OF THE DISCLOSURE

A service providing system according to the present disclosure executes connection to a micro-service according to a specific request in a case where the service providing system has received the specific request, which is a specific application programming interface (API) request assigned specific identification information, and where the number of times of reception of the API request assigned the specific identification information has not exceeded a specific rate limit. The specific identification information is identification information of a specific client. The specific rate limit is a rate limit associated with the specific identification information. The service providing system updates the specific rate limit in accordance with a whole load of all the micro-services that operate in response to the specific request in a case where the service providing system has received the specific request.

An information processing apparatus according to the present disclosure executes connection to a micro-service according to a specific request in a case where the information processing apparatus has received the specific request, which is a specific application programming interface (API) request assigned specific identification information, and where the number of times of reception of the API request assigned the specific identification information has not exceeded a specific rate limit. The specific identification information is identification information of a specific client. The specific rate limit is a rate limit associated with the specific identification information. The information processing apparatus updates the specific rate limit in accordance with a whole load of all the micro-services that operate in response to the specific request in a case where the information processing apparatus has received the specific request.

A service providing program according to the present disclosure is a service providing program that is executed by a computer. The service providing program causes the computer to execute connection to a micro-service according to a specific request in a case where the computer has received the specific request, which is a specific application programming interface (API) request assigned specific identification information, and where the number of times of reception of the API request assigned the specific identification information by the computer has not exceeded a specific rate limit The specific identification information is identification information of a specific client. The specific rate limit is a rate limit associated with the specific identification information. The service providing program causes the computer to update the specific rate limit in accordance with a whole load of all the micro-services that operate in response to the specific request in a case where the computer has received the specific request.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a block diagram of a system according to an embodiment of the present disclosure.

FIG. 2 is a block diagram of an example of the service providing system shown in FIG. 1 in a case where it is constituted by a single computer.

FIG. 3 is a diagram showing an example of user management information shown in FIG. 2.

FIG. 4 is a diagram showing an example of rate limit management information shown in FIG. 2.

FIG. 5 is a diagram showing an example of API request history information shown in FIG. 2.

FIG. 6 is a block diagram of an example of the user terminal shown in FIG. 1.

FIG. 7 is a flowchart of an operation of the service providing system shown in FIG. 2 in a case of receiving an API request from a client.

FIG. 8 is a flowchart of an example of an operation of the service providing system shown in FIG. 2 in a case where it determines whether or not the number of times of reception of an API request, which has been assigned client identification information assigned to a target request, has exceeded a rate limit.

FIG. 9 is a sequence diagram of an operation of the system shown in FIG. 1 in a case where the user terminal displays a user webpage.

FIG. 10 is a flowchart of an operation of the service providing system shown in FIG. 2 in a case of resetting the rate limit to a default rate limit.

FIG. 11 is a block diagram of an example of the service providing system shown in FIG. 1 in a case where it is constituted by a single computer.

FIG. 12 is a diagram showing an example of client management information shown in FIG. 11.

FIG. 13 is a diagram showing an example of tenant management information shown in FIG. 11.

FIG. 14 is a diagram showing an example of unfinished request management information shown in FIG. 11.

FIG. 15 is a diagram showing an example of request history information shown in FIG. 11.

FIG. 16 is a flowchart of an operation of the service providing system shown in FIG. 11 in a case of receiving an API request from a client.

FIG. 17 is a flowchart of priority determination processing shown in FIG. 16.

FIG. 18 is a flowchart of an operation of the service providing system shown in FIG. 11 when a priority is written in the unfinished request management information in a case where a first priority processing rule is indicated by priority processing rule information.

FIG. 19 is a flowchart of an operation of the service providing system shown in FIG. 11 when a processing order of a low-priority request is written in the unfinished request management information in a case where the first priority processing rule is indicated by the priority processing rule information.

FIG. 20 is a flowchart of an operation of the service providing system shown in FIG. 11 when determining to start processing of the API request in a case where the first priority processing rule is indicated by the priority processing rule information.

FIG. 21 is a flowchart of an operation of the service providing system shown in FIG. 11 in a case where a second priority processing rule is indicated by the priority processing rule information when the priority is written in the unfinished request management information.

FIG. 22 is a flowchart of an operation of the service providing system shown in FIG. 11 when an API interface unit receives a result of the processing of the API request from a backend service server in a case where a third priority processing rule is indicated by the priority processing rule information.

FIG. 23 is a flowchart of an operation of the service providing system shown in FIG. 11 when determining to start the processing of the API request in a case where the third priority processing rule is indicated by the priority processing rule information.

### DETAILED DESCRIPTION OF THE EXEMPLARY EMBODIMENTS

### First Embodiment

Hereinafter, an embodiment of the present disclosure will be described with reference to the drawings.

First of all, configurations of the system according to the embodiment of the present disclosure will be described.

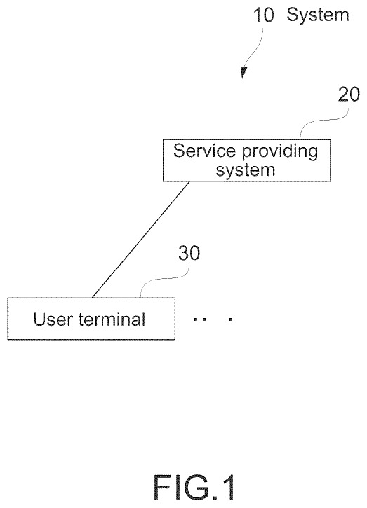

FIG. 1 is a block diagram of a system 10 according to the present embodiment.

As shown in FIG. 1, the system 10 includes a service providing system 20 that provides a service used by a user terminal used by a user. The service providing system 20 may be constituted by a single computer, such as a personal computer (PC), or may be constituted by multiple computers. The service providing system 20 may be configured on a cloud.

The system 10 includes a user terminal 30 that is used by a user. The system 10 may include at least one user terminal with a configuration similar to that of the user terminal 30 in addition to the user terminal 30. The user terminal may be constituted by a computer, such as a PC.

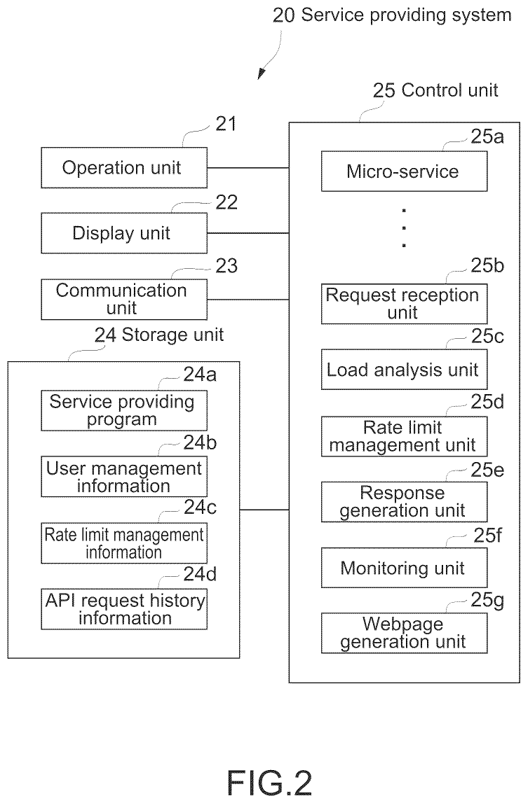

FIG. 2 is a block diagram of an example of the service providing system 20 in a case where it is constituted by a single computer.

As shown in FIG. 2, the service providing system 20 includes an operation unit 21, a display unit 22, a communication unit 23, a storage unit 24, and a control unit 25. The operation unit 21 is an operation device to which various operations are input, such as keyboard and mouse. The display unit 22 is a display device that displays various types of information, such as a liquid crystal display (LCD). The communication unit 23 is a communication device that communicates with an external apparatus via a network, such as a local area network (LAN) or Internet, or directly with a wire or wirelessly without the network. The storage unit 24 is a nonvolatile storage device that stores various types of information, such as a semiconductor memory or a hard disk drive (HDD). The control unit 25 comprehensively controls the service providing system 20.

The storage unit 24 is capable of storing a service providing program 24a for providing a cloud service. For example, the service providing program 24a may be installed in the service providing system 20 during the production phase of the service providing system 20. Alternatively, for example, the service providing program 24a may be additionally installed in the service providing system 20 from an external storage medium such as a universal serial bus (USB) memory. Alternatively, for example, the service providing program 24a may be additionally installed in the service providing system 20 from the network.

The storage unit 24 is capable of storing user management information 24b for managing users of the service providing system 20.

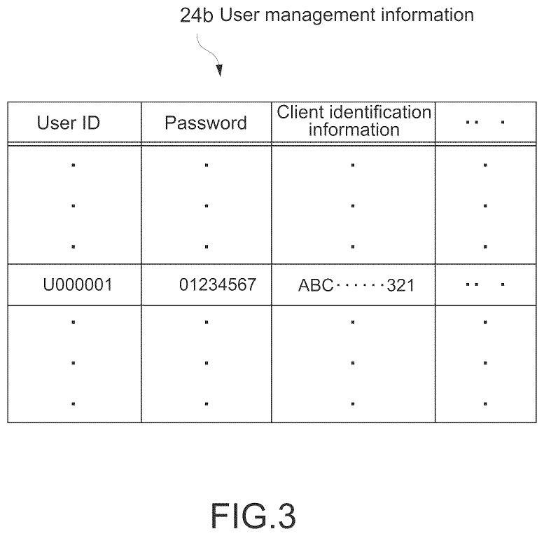

FIG. 3 is a diagram showing an example of the user management information 24b.

The user management information 24b shown in FIG. 3 includes, for each user, a user ID that is identification information of the user, a password of the user, and identification information of a client, which is produced by the user (hereinafter, the identification information of the client will be referred to as “client identification information”). Regarding a user who has produced a plurality of clients, the user management information 24b is associated with a plurality of pieces of client identification information. Regarding a user who has produced no client, the user management information 24b is associated with no client identification information. The user management information 24b shown in FIG. 3 is depicted with some information omitted.

As shown in FIG. 2, the storage unit 24 is capable of storing rate limit management information 24c for managing rate limits of an application programming interface (API).

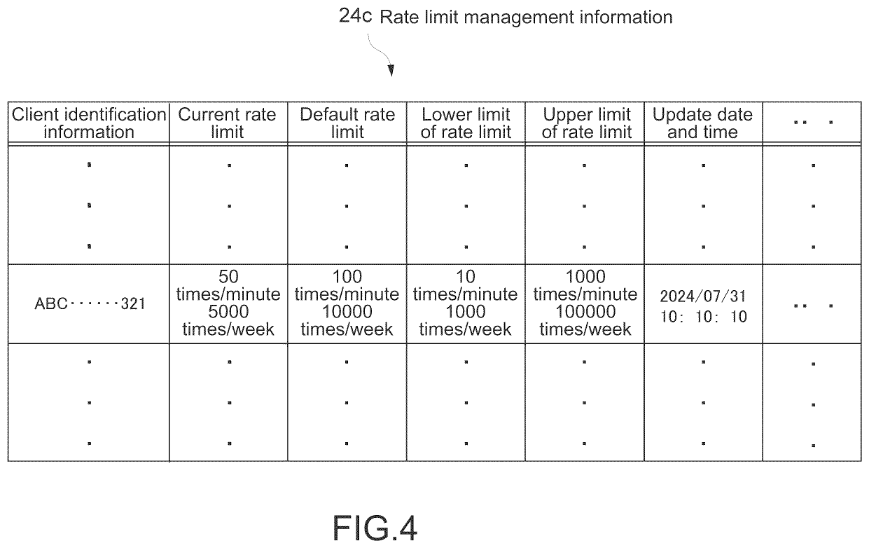

FIG. 4 is a diagram showing an example of the rate limit management information 24c.

As shown in FIG. 4, the rate limit management information 24c includes, for each client, client identification information, a current rate limit with respect to the client, a default rate limit with respect to the client, a lower limit of the rate limit with respect to the client, an upper limit of the rate limit with respect to the client, and update date and time indicating the date and time when the rate limit with respect to the client is updated. The rate limit management information 24c shown in FIG. 4 is depicted with some information omitted.

For example, the client identification information may be issued by an operator of the service providing system 20. As the client identification information, the same one may be issued irrespective of the types of clients as long as these are clients produced by the same producer or different ones may be issued depending on the types of clients even in a case where these are clients produced by the same producer.

As shown in FIG. 2, the storage unit 24 is capable of storing API request history information 24d indicating a history of API requests.

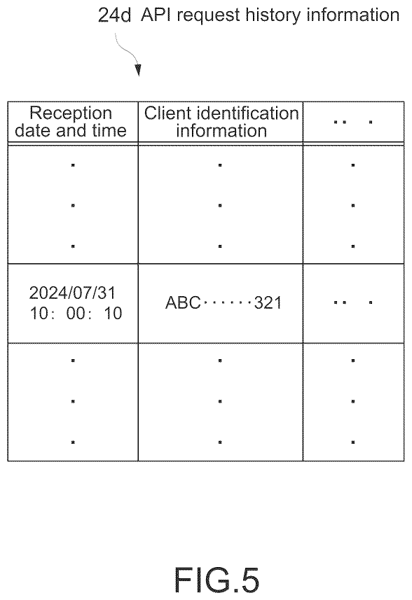

FIG. 5 is a diagram showing an example of the API request history information 24d.

As shown in FIG. 5, the API request history information 24d includes, for each API request, reception date and time of the API request and client identification information assigned to the API request. The API request history information 24d shown in FIG. 5 is depicted with some information omitted.

For example, the control unit 25 shown in FIG. 2 includes a central processing unit (CPU), a read only memory (ROM) that stores programs and various data, and a random access memory (RAM) that serves as a memory used as a working area for the CPU of the control unit 25. The CPU of the control unit 25 executes the programs stored in the storage unit 24 or the ROM of the control unit 25.

By executing the service providing program 24a, the control unit 25 realizes a micro-service such as a micro-service 25a, a request reception unit 25b, a load analysis unit 25c, a rate limit management unit 25d, a response generation unit 25e, a monitoring unit 25f, and a webpage generation unit 25g. The request reception unit 25b receives an API request from a client. The load analysis unit 25c analyzes a load of the micro-services. The rate limit management unit 25d manages rate limits of an API. The response generation unit 25e generates an API response. The monitoring unit 25f monitors the rate limit management unit 25d and includes a rate limit update notification in a user webpage. The webpage generation unit 25g generates a webpage.

For example, the load analysis unit 25c is capable of quantifying the load of the micro-services on the basis of a use rate of the CPU of the service providing system 20 by the micro-service, the use rate of the RAM of the service providing system 20 by the micro-service, and a response time by the micro-service, i.e., a processing time of the API request. For example, the load analysis unit 25c is capable of calculating the load of the micro-services as a percentage.

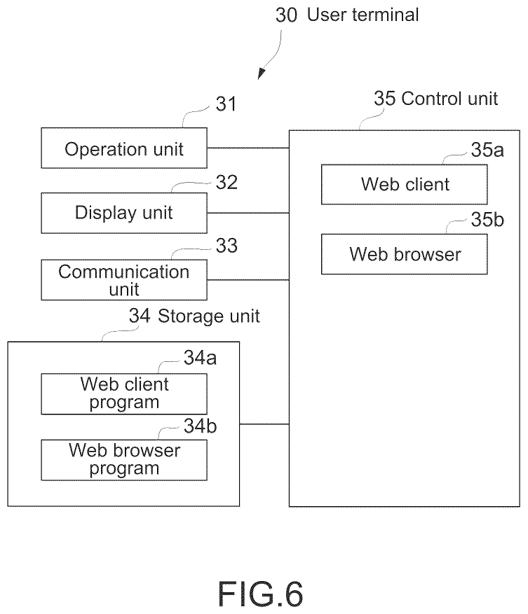

FIG. 6 is a block diagram of an example of the user terminal 30.

As shown in FIG. 6, the user terminal 30 includes an operation unit 31, a display unit 32, a communication unit 33, a storage unit 34, and a control unit 35. The operation unit 31 is an operation device to which various operations are input, such as keyboard and mouse. The display unit 32 is a display device that displays various types of information, such as a liquid crystal display (LCD). The communication unit 33 is a communication device that communicates with an external apparatus via a network, such as a local area network (LAN) or Internet, or directly with a wire or wirelessly without the network. The storage unit 34 is a nonvolatile storage device that stores various types of information, such as a semiconductor memory or a hard disk drive (HDD). The control unit 35 comprehensively controls the user terminal 30.

The storage unit 34 is capable of storing a client program 34a for a client and a web browser program 34b for a web browser. For example, each of the client program 34a and the web browser program 34b may be installed in the user terminal 30 during the production phase of the user terminal 30. Alternatively, for example, each of the client program 34a and the web browser program 34b may be additionally installed in the user terminal 30 from an external storage medium such as a USB memory. Alternatively, for example, each of the client program 34a and the web browser program 34b may be additionally installed in the user terminal 30 from the network.

For example, the control unit 35 includes a central processing unit (CPU), a read only memory (ROM) that stores programs and various data, and a random access memory (RAM) that serves as a memory used as a working area for the CPU of the control unit 35. The CPU of the control unit 35 executes the programs stored in the storage unit 34 or the ROM of the control unit 35.

The control unit 35 realizes a client 35a by executing client program 34a.

The control unit 35 realizes a web browser 35b by executing the web browser program 34b.

The user of the user terminal 30 may be a producer of the client 35a or may be a person other than the producer of the client 35a.

Next, an operation of the system 10 will be described.

It should be noted that hereinafter, the user terminal 30 will be described, representing the user terminal. However, a user terminal other than the user terminal 30 is also capable of executing an operation similar to that of the user terminal 30.

First of all, an operation of the service providing system 20 in a case of receiving an API request from the client 35a will be described.

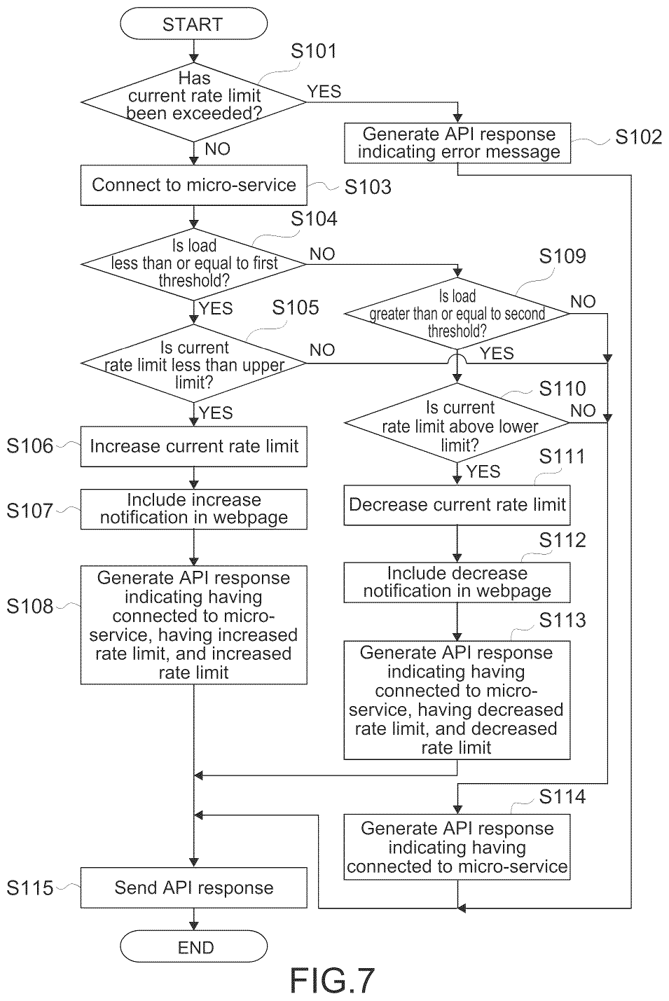

FIG. 7 is a flowchart of the operation of the service providing system 20 in a case of receiving the API request from the client 35a.

In a case of using the API provided by the service providing system 20, the client 35a sends an API request, which has been assigned the client identification information of the client 35a, to the service providing system 20. For example, the client 35a may apply the client identification information of the client 35a to the API request as an API key. In a case where the service providing system 20 receives the API request, the service providing system 20 executes the operation shown in FIG. 7. Hereinafter, the API request that has caused the service providing system 20 to start the operation shown in FIG. 7 will be referred to as a “target request” in the description of the operation shown in FIG. 7.

As shown in FIG. 7, the request reception unit 25b of the service providing system 20 determines whether or not the number of times of reception of the API request, which has been assigned the client identification information assigned to the target request, has exceeded a current rate limit associated with the client identification information assigned to the target request in the rate limit management information 24c (S101).

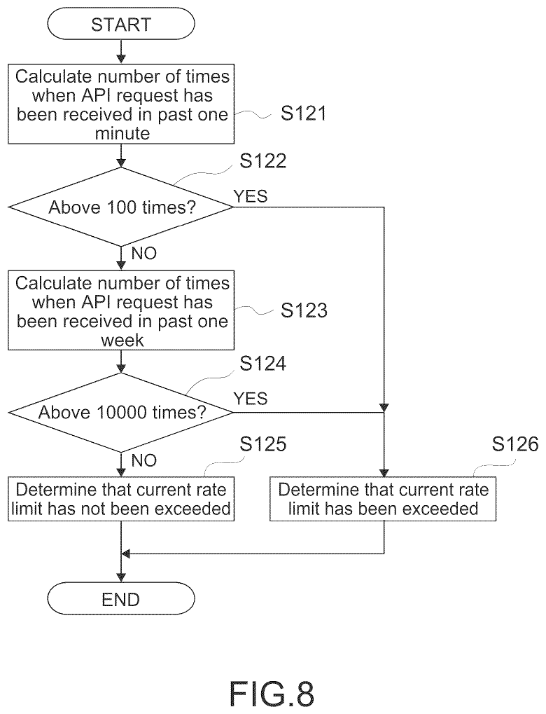

For example, in a case where the current rate limit associated with the client identification information assigned to the target request in the rate limit management information 24c is “100 times/minute or 10000 times/week,” the request reception unit 25b determines whether or not the number of times of reception of the API request, which has been assigned the client identification information assigned to the target request, has exceeded the current rate limit associated with the client identification information assigned to the target request in the rate limit management information 24c as shown in FIG. 8.

FIG. 8 is a flowchart of an example of an operation of the service providing system 20 in a case where it determines whether or not the number of times of reception of the API request, which has been assigned the client identification information assigned to the target request, has exceeded the rate limit.

As shown in FIG. 8, the request reception unit 25b calculates the number of times the request reception unit 25b has received the API request, which has been assigned client identification information identical to the client identification information assigned to the target request, in the past one minute starting from the current date and time on the basis of the API request history information 24d (S121).

When the processing of S121 ends, the request reception unit 25b determines whether or not the number of times calculated in S121 has exceeded 100 times (S122).

When the request reception unit 25b determines in S122 that the number of times calculated in S121 has not exceeded 100 times, the request reception unit 25b calculates, on the basis of the API request history information 24d, the number of times the request reception unit 25b has received the API request, which has been assigned client identification information identical to the client identification information assigned to the target request, in the past one week starting from the current date and time (S123).

When the processing of S123 ends, the request reception unit 25b determines whether or not the number of times calculated in S123 has exceeded 10000 times (S124).

When the request reception unit 25b determines in S124 that the number of times calculated in S123 has not exceeded 10000 times, the request reception unit 25b determines that the number of times of reception of the API request, which has been assigned the client identification information assigned to the target request, has not exceeded the current rate limit associated with the client identification information assigned to the target request in the rate limit management information 24c (S125), and terminates the operation shown in FIG. 8.

When the request reception unit 25b determines in S122 that the number of times calculated in S121 has exceeded 100 times or when the request reception unit 25b determines in S124 that the number of times calculated in S123 has exceeded 10000 times, the request reception unit 25b determines that the number of times of reception of the API request, which has been assigned the client identification information assigned to the target request, has exceeded the current rate limit associated with the client identification information assigned to the target request in the rate limit management information 24c (S126), and terminates the operation shown in FIG. 8.

Hereinabove, the case where the current rate limit associated with the client identification information assigned to the target request in the rate limit management information 24c is “100 times/minute or 10000 times/week” has been described. However, the same applies to a rate limit other than “100 times/minute or 10000 times/week”.

As shown in FIG. 7, when the request reception unit 25b determines in S101 that the number of times of reception of the API request, which has been assigned the client identification information assigned to the target request, has exceeded the current rate limit associated with the client identification information assigned to the target request in the rate limit management information 24c, the response generation unit 25e generates an API response including an error message indicating that the service cannot be provided because the rate limit has been exceeded (S102).

When the request reception unit 25b determines in S101 that the number of times of reception of the API request, which has been assigned the client identification information assigned to the target request, has not exceeded the current rate limit associated with the client identification information assigned to the target request in the rate limit management information 24c, the request reception unit 25b connects to a micro-service according to the target request (S103). The micro-service that operates in response to the target request thus starts the operation.

When the processing of S103 ends, the load analysis unit 25c determines whether or not the whole load of all micro-services that operate in response to the target request is less than or equal to a first threshold (S104). For example, the first threshold in S104 is 30%.

When the load analysis unit 25c determines in S104 that the whole load of all micro-services that operate in response to the target request is less than or equal to the first threshold, the rate limit management unit 25d determines whether or not the current rate limit associated with the client identification information assigned to the target request in the rate limit management information 24c is less than the upper limit associated with the client identification information assigned to the target request in the rate limit management information 24c (S105).

When the rate limit management unit 25d determines in S105 that the current rate limit associated with the client identification information assigned to the target request in the rate limit management information 24c is less than the upper limit associated with the client identification information assigned to the target request in the rate limit management information 24c, the rate limit management unit 25d increases the current rate limit associated with the client identification information assigned to the target request in the rate limit management information 24c in accordance with a specific rule (S106). It should be noted that the rate limit management unit 25d in S106 is capable of increasing the rate limit only to the upper limit associated with the client identification information assigned to the target request in the rate limit management information 24c. Moreover, the rate limit management unit 25d stores the date and time when the rate limit management unit 25d executes the processing of S106 as update date and time, in association with the client identification information assigned to the target request in the rate limit management information 24c.

When the processing of S106 ends, the monitoring unit 25f includes a notification of having increased the rate limit and of the rate limit increased in S106 (hereinafter, referred to as “increase notification”) in a user webpage identified by a user ID associated with the client identification information assigned to the target request in the user management information 24b, i.e., a producer webpage of a client identified by the client identification information assigned to the target request (S107).

When the processing of S107 ends, the response generation unit 25e generates an API response indicating having connected to the micro-service, having increased the rate limit, and the rate limit increased in S106 (S108). For example, the response generation unit 25e may include having increased the rate limit and the rate limit increased in S106 in the header of the API response. It should be noted that in a case where the client 35a receives the API response including having increased the rate limit and the rate limit increased in S106, the client 35a is, for example, capable of displaying the increase in the rate limit and the increased rate limit on the display unit 32 or the like and reflecting the increase in the rate limit and the increased rate limit to some operation.

When the load analysis unit 25c determines in S104 that the whole load of all micro-services that operate in response to the target request is not less than or equal to the first threshold, the load analysis unit 25c determines whether or not the whole load of all micro-services that operate in response to the target request is greater than or equal to a second threshold (S109). The second threshold in S109 is greater than the first threshold in S104. For example, the second threshold in S109 is 80%.

When the load analysis unit 25c determines in S109 that the whole load of all micro-services that operate in response to the target request is greater than or equal to the second threshold, the rate limit management unit 25d determines whether or not the current rate limit associated with the client identification information assigned to the target request in the rate limit management information 24c is above a lower limit associated with the client identification information assigned to the target request in the rate limit management information 24c (S110).

When the rate limit management unit 25d determines in S110 that the current rate limit associated with the client identification information assigned to the target request in the rate limit management information 24c is above the lower limit associated with the client identification information assigned to the target request in the rate limit management information 24c, the rate limit management unit 25d decreases the current rate limit associated with the client identification information assigned to the target request in the rate limit management information 24c in accordance with the specific rule (S111). It should be noted that the rate limit management unit 25d is capable of decreasing the rate limit in S111 only to the lower limit associated with the client identification information assigned to the target request in the rate limit management information 24c. Moreover, the rate limit management unit 25d stores the date and time when the rate limit management unit 25d executes the processing of S111 as update date and time, in association with the client identification information assigned to the target request in the rate limit management information 24c.

When the processing of S111 ends, the monitoring unit 25f includes a notification of having decreased the rate limit and of the rate limit decreased in S111 (hereinafter, referred to as “decrease notification”) in a user webpage identified by a user ID associated with the client identification information assigned to the target request in the user management information 24b, i.e., a producer webpage of a client identified by the client identification information assigned to the target request (S112).

When the processing of S112 ends, the response generation unit 25e generates an API response indicating having connected to the micro-service, having decreased the rate limit, and the rate limit decreased in S111 (S113). For example, the response generation unit 25e may include having decreased the rate limit and the rate limit decreased in S111 in the header of the API response. It should be noted that in a case where the client 35a receives the API response including having decreased the rate limit and the rate limit decreased in S111, the client 35a is, for example, capable of displaying the decrease in the rate limit and the decreased rate limit on the display unit 32 or the like and reflecting the decrease in the rate limit and the decreased rate limit to some operation.

When the response generation unit 25e determines in S105 that the current rate limit associated with the client identification information assigned to the target request in the rate limit management information 24c is not less than the upper limit associated with the client identification information assigned to the target request in the rate limit management information 24c, when the response generation unit 25e determines in S109 that the whole load of all micro-services that operate in response to the target request is not greater than or equal to the second threshold, or when the response generation unit 25e determines in S110 that the current rate limit associated with the client identification information assigned to the target request in the rate limit management information 24c is not above the lower limit associated with the client identification information assigned to the target request in the rate limit management information 24c, the response generation unit 25e generates an API response indicating having connected to the micro-service (S114).

When the processing of S102, S108, S113, or S114 ends, the request reception unit 25b sends (S115) the API response generated in S102, S108, S113, or S114 to the client, which is a source of the target request, and terminates the operation shown in FIG. 7.

Next, an operation of the system 10 in a case where the user terminal 30 displays the user webpage will be described.

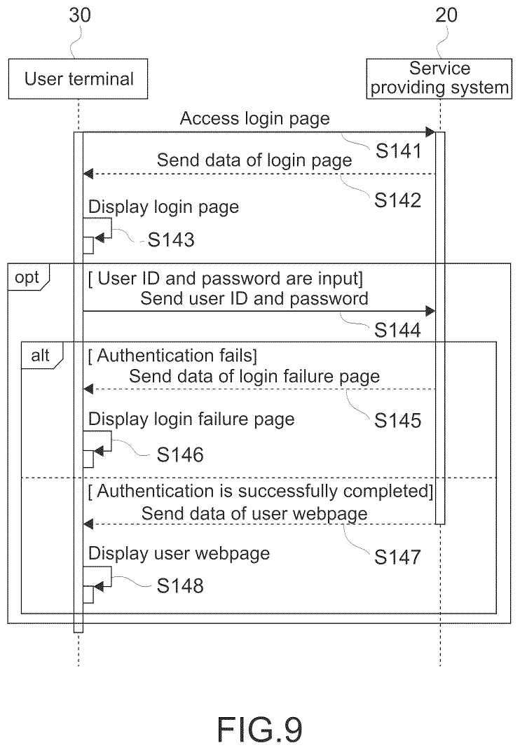

FIG. 9 is a sequence diagram of the operation of the system 10 in a case where the user terminal 30 displays the user webpage.

The user is capable of instructing the user terminal 30 to access a login webpage to the service providing system 20 (hereinafter, referred to as “login page”) via the operation unit 31 of the user terminal 30. When the web browser 35b of the user terminal 30 is instructed to access the login page, the web browser 35b of the user terminal 30 accesses the login page as shown in FIG. 9 (S141).

When the webpage generation unit 25g of the service providing system 20 receives the access in S141, the webpage generation unit 25g of the service providing system 20 sends data of the login page to the web browser 35b (S142).

When the web browser 35b receives the data sent in S142, the web browser 35b displays the login page on the display unit 32 on the basis of the received data (S143). Therefore, the user is capable of inputting a combination of the user ID and the password of the user to the login page displayed on the display unit 32.

When the user ID and the password are input to the login page, the web browser 35b sends the input combination of the user ID and the password to the service providing system 20 (S144).

In a case where the combination of the user ID and the password sent in S144 has not been stored in the user management information 24b, i.e., in a case where the user's authentication has failed, the webpage generation unit 25g of the service providing system 20 sends data on a webpage showing the login failure (hereinafter, referred to as “login failure page”) to the web browser 35b (S145).

When the web browser 35b receives the data sent in S145, the web browser 35b displays the login failure page on the display unit 32 on the basis of the received data (S146).

In a case where the combination of the user ID and the password sent in S144 has been stored in the user management information 24b, i.e., in a case where the user's authentication has been successfully completed, the webpage generation unit 25g of the service providing system 20 sends data on a user webpage identified by the user ID sent in S144 to the web browser 35b (S147).

When the web browser 35b receives the data sent in S147, the web browser 35b displays a webpage based on the received data on the display unit 32 (S148). Here, in a case where the user is the producer of the client and where the user webpage includes the increase notification, the user is capable of recognizing the increase in the rate limit and the increased rate limit. Moreover, in a case where the user is the producer of the client and where the user webpage includes the decrease notification, the user is capable of recognizing the decrease in the rate limit and the decreased rate limit.

Next, an operation of the service providing system 20 in a case of resetting the rate limit to the default rate limit will be described.

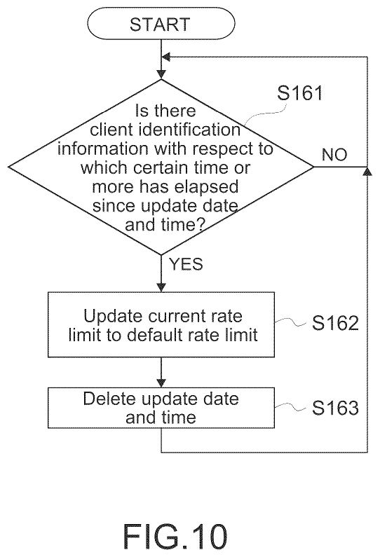

FIG. 10 is a flowchart of the operation of the service providing system 20 in a case of resetting the rate limit to the default rate limit.

As shown in FIG. 10, the rate limit management unit 25d determines whether or not there is client identification information with respect to which the current date and time have passed a certain time or more since the update date and time in the rate limit management information 24c until the rate limit management unit 25d determines that there is client identification information with respect to which the current date and time have passed the certain time or more since the update date and time in the rate limit management information 24c (S161). For example, the certain time in S161 may be several tens of minutes.

When the rate limit management unit 25d determines in S161 that there is client identification information with respect to which the current date and time have passed the certain time or more since the update date and time in the rate limit management information 24c, the rate limit management unit 25d updates the current rate limit with respect to which the current date and time have passed the certain time or more since the update date and time in the rate limit management information 24c to the default rate limit associated with the client identification information in the rate limit management information 24c (S162).

When the processing of S162 ends, the rate limit management unit 25d deletes the update date and time associated with the client identification information in the rate limit management information 24c, with respect to which the current rate limit has been updated in S162 (S163), and executes the processing of S161.

As described above, in a case where the service providing system 20 receives an API request, which has been assigned identification information of a specific client, the service providing system 20 updates the current rate limit associated with the identification information of the specific client in accordance with the whole load of all micro-services that operate in response to the received API request (S104 to S106 and S109 to S111). Therefore, the service providing system 20 is capable of operating in accordance with the load of the micro-services that operate in response to the API request.

In a case where the service providing system 20 receives the API request, which has been assigned the identification information of the specific client, and where the whole load of all micro-services that operate in response to the received API request is less than or equal to the first threshold (YES in S104), the service providing system 20 increases the current rate limit associated with the identification information of the specific client (S106). Therefore, the service providing system 20 is capable of enhancing the convenience in a case where there is spare capacity in the load of the micro-services.

In a case where the service providing system 20 receives the API request, which has been assigned the identification information of the specific client, and where the whole load of all micro-services that operate in response to the received API request is greater than or equal to the second threshold (YES in S109), the service providing system 20 decreases the current rate limit associated with the identification information of the specific client (S111). Therefore, the service providing system 20 is capable of reducing the possibility that the load of the micro-services excessively increases. Therefore, the service providing system 20 is also capable of reducing the possibility that the service providing system 20 itself cannot be temporarily used due to an excessive increase in the load of the micro-services.

In a case where the service providing system 20 receives the API request, which has been assigned the identification information of the specific client, and where the service providing system 20 updates the current rate limit associated with the identification information of the specific client (S106 or S111), the service providing system 20 sends an API response indicating that the service providing system 20 has updated the current rate limit associated with the identification information of the specific client to the source of the API request (S108 or S113, and S115). Therefore, the service providing system 20 is capable of enhancing the convenience in the client. That is, as described above, the client is capable of reflecting the increase or decrease in the rate limit to some operation.

In addition, the service providing system 20 includes the updated current rate limit, which has been associated with the identification information of the specific client, in the API response (S108 or S113). Therefore, the service providing system 20 is capable of further enhancing the convenience in the client. That is, as described above, the client is capable of reflecting the increased or decreased rate limit to some operation.

In a case where the service providing system 20 receives the API request, which has been assigned the identification information of the specific client, and where the service providing system 20 updates the current rate limit associated with the identification information of the specific client (S106 or S111), the service providing system 20 includes having updated the current rate limit associated with the identification information of the specific client in the webpage associated with the identification information of the specific client (S107 or S112). Therefore, the service providing system 20 is capable of enhancing the convenience of the user who can view this webpage.

In addition, the service providing system 20 includes the updated current rate limit, which has been associated with the identification information of the specific client, in the webpage associated with the identification information of the specific client (S107 or S112). Therefore, the service providing system 20 is capable of further enhancing the convenience of the user who can view this webpage.

In a case where the current date and time have passed the certain time or more since the latest update date and time of the current rate limit associated with the identification information of the specific client (YES in S161), the service providing system 20 updates the current rate limit associated with the identification information of the specific client to the default rate limit (S162). Therefore, the service providing system 20 is capable of reducing the possibility that the state in which the current rate limit is different from the default rate limit continues for a long period.

### Second Embodiment

Hereinafter, an embodiment of the present disclosure will be described with reference to the drawings.

First of all, configurations of the system according to the embodiment of the present disclosure will be described. Hereinafter, descriptions of some of the configurations, which are similar to those already described, may be omitted. Moreover, processing described below may be executed with the processing described above.

A block diagram of the system 10 according to the present embodiment is similar to that shown in FIG. 1.

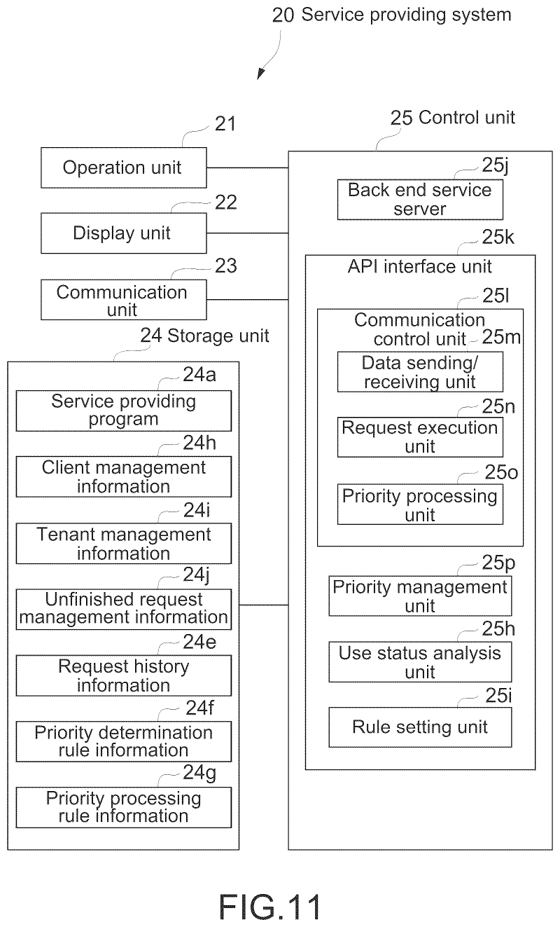

FIG. 11 is a block diagram of an example of the service providing system 20 in a case where it is constituted by a single computer.

A storage unit 24 is capable of storing a service providing program 24a for providing a service. Moreover, the storage unit 24 is capable of storing client management information 24h that manages clients that are applications using the service providing system 20. The client management information 24h may be configured as a database.

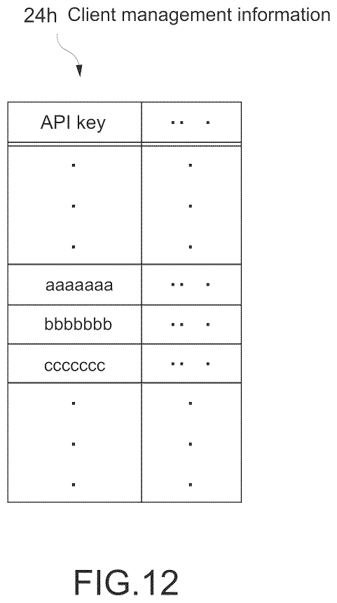

FIG. 12 is a diagram showing an example of the client management information 24h.

As shown in FIG. 12, the client management information 24h includes, for each client, an application programming interface (API) key that is identification information of the client. The client management information 24h shown in FIG. 12 is depicted with some information omitted.

For example, the API key may be issued by the operator of the service providing system 20. As the API key, the same one may be issued irrespective of the types of clients as long as these are clients produced by the same producer or different ones may be issued depending on the types of clients even in a case where these are clients produced by the same producer.

As shown in FIG. 11, the storage unit 24 is capable of storing tenant management information 24i that manages tenants of the service providing system 20. The tenant management information 24i may be configured as a database.

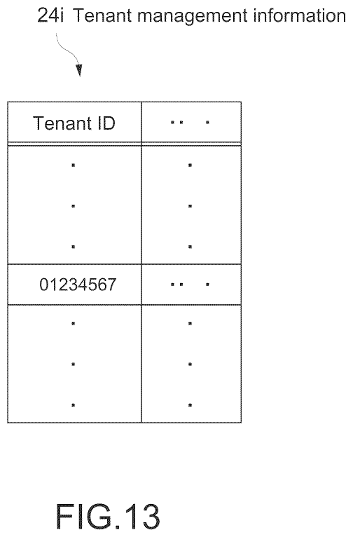

FIG. 13 is a diagram showing an example of the tenant management information 24i.

As shown in FIG. 13, the tenant management information 24i includes, for each tenant, a tenant ID that is identification information of the tenant. The tenant management information 24i shown in FIG. 13 is depicted with some information omitted.

As shown in FIG. 11, the storage unit 24 is capable of storing unfinished request management information 24j for managing API requests with respect to which the processing has not been finished yet. The unfinished request management information 24j may be configured as a database.

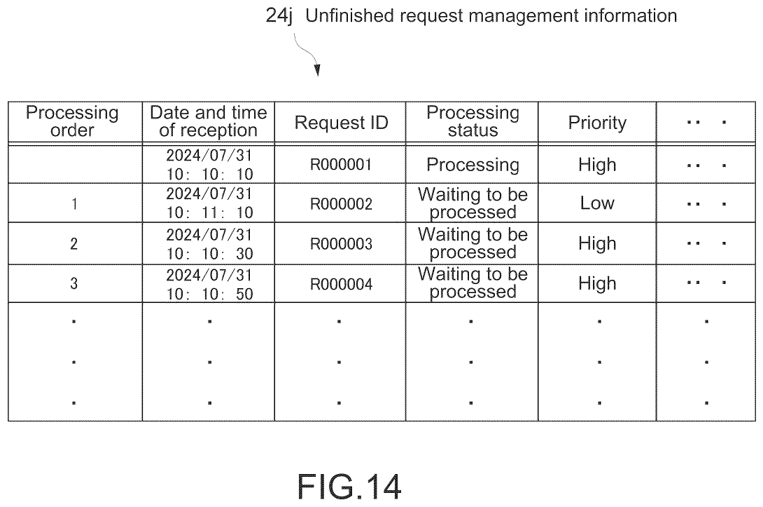

FIG. 14 is a diagram showing an example of the unfinished request management information 24j.

As shown in FIG. 14, the unfinished request management information 24j includes, for each API request, the order of processing of the API request by the service providing system 20 (hereinafter, referred to as “processing order”), reception date and time of the API request by the service providing system 20, a request ID that is identification information of the API request, a status of the processing of the API request (hereinafter, referred to as “processing status”), and a priority assigned to the API request. The unfinished request management information 24j shown in FIG. 14 is depicted with some information omitted.

Regarding the processing order of the API request, “1” is the earliest order, and the order becomes one later as the numeric value increases by one.

The processing status of the API request includes “waiting to be processed” indicating a status of waiting to be processed by the service providing system 20 and “in process” indicating a status of being processed by the service providing system 20.

Two priorities are assigned to API requests. A higher priority of the two priorities will be referred to as a high priority and a lower priority will be referred to as a low priority. Hereinafter, the API request with the high priority will be referred to as a high-priority request and the API request with the low priority will be referred to as a low-priority request.

As shown in FIG. 11, the storage unit 24 is capable of storing request history information 24e indicating the history of API requests. The request history information 24e may be configured as a database.

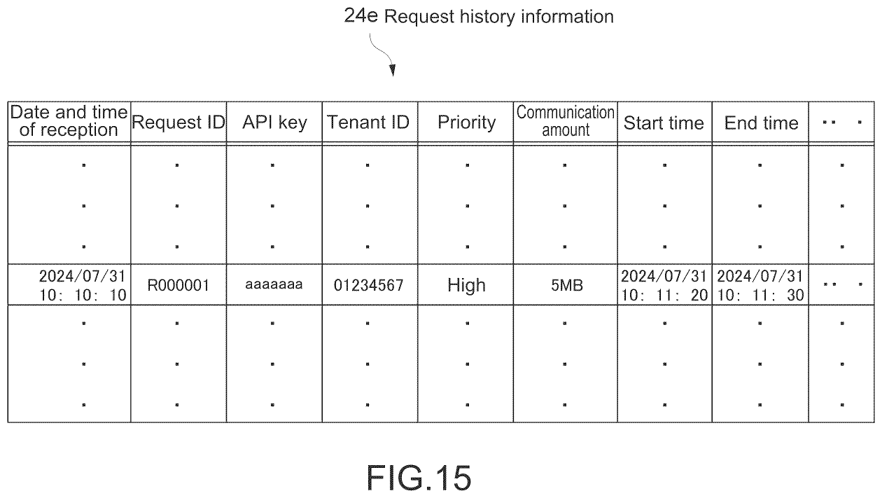

FIG. 15 is a diagram showing an example of the request history information 24e.

As shown in FIG. 15, the request history information 24e includes, for each API request, reception date and time of the API request by the service providing system 20, a request ID of the API request, an API key assigned to the API request, a tenant ID assigned to the API request, a priority assigned to the API request, a communication amount of data in processing of the API request by a backend service server 25j, a start time of the processing of the API request by the backend service server 25j, and an end time of the processing of the API request by the backend service server 25j. The request history information 24e shown in FIG. 15 is depicted with some information omitted.

As shown in FIG. 11, the storage unit 24 stores priority determination rule information 24f indicating a priority determination rule that is a rule for determining the priority of the API request. Various rules can be employed as a priority determination rule indicated by the priority determination rule information 24f.

The storage unit 24 has stored priority processing rule information 24g. The priority processing rule information 24g indicates a priority processing rule indicating how to execute priority processing that is processing of the API request according to the priority of the API request.

Various rules can be employed as the priority processing rule indicated by the priority processing rule information 24g. For example, as the priority processing rule indicated by the priority processing rule information 24g, a priority processing rule that processes a new request with a lower priority (hereinafter, referred to as “new low-priority request”) when a specific number or more of high-priority requests have been processed after the processing of the previous low-priority request in a case where the new low-priority request has been received in a state in which there are no low-priority requests waiting to be processed and that processes the new low-priority request when a certain time has elapsed since the new low-priority request is received in a case where the specific number or more of high-priority requests have not been processed after the processing of the previous low-priority request can be employed (hereinafter, this rule will be referred to as “first priority processing rule”). As the priority processing rule indicated by the priority processing rule information 24g, a priority processing rule that processes the new low-priority request when a first time or more has elapsed since the processing of the previous low-priority request in a case where the new low-priority request has been received in a state in which there are no low-priority requests waiting to be processed and that processes the new low-priority request when a second time has elapsed since the new low-priority request is received in a case where the first time has not passed after the processing of the previous low-priority request can be employed (hereinafter, this rule will be referred to as referred to as “second priority processing rule”). As the priority processing rule indicated by the priority processing rule information 24g, a priority processing rule that processes one of the low-priority requests every time a specific number of high-priority requests are processed in a case where there are no low-priority requests waiting to be processed for the certain time or more and that processes, in a case where there are low-priority requests waiting to be processed for the certain time or more, the low-priority request waiting to be processed for the certain time or more preceding the high-priority request can be employed (hereinafter, this rule will be referred to as “third priority processing rule”).

The control unit 25 realizes the backend service server 25j that executes processing according to the API request received from the client and an API interface unit 25k that is a server that serves as an intermediate layer between the client and the backend service server 25j by executing the service providing program 24a. The API interface unit 25k includes a communication control unit 25l that controls API communication with the client. The communication control unit 25l includes a data sending/receiving unit 25m, a request execution unit 25n, and a priority processing unit 25o. The data sending/receiving unit 25m receives an API request from the client and sends the API response to the client. The request execution unit 25n communicates with the backend service server 25j in order to process the API request received from the client. The priority processing unit 25o executes priority processing, which is the processing of the API request according to the priority of the API request, between the data sending/receiving unit 25m and the request execution unit 25n. The API interface unit 25k realizes a priority management unit 25p, a use status analysis unit 25h, and a rule setting unit 25i. The priority management unit 25p manages priorities of the API request. The use status analysis unit 25h analyzes a use status of the service providing system 20 according to the API request. The rule setting unit 25i sets the priority determination rule and the priority processing rule.

The rule setting unit 25i is capable of changing the priority determination rule indicated by the priority determination rule information 24f and the priority processing rule indicated by the priority processing rule information 24g in accordance with an instruction via the operation unit 21 or the communication unit 23.

A block diagram of the user terminal 30 in the present embodiment is similar to that shown in FIG. 6.

Next, an operation of the service providing system 20 in a case of receiving the API request from the client 35a will be described.

It should be noted that hereinafter, the user terminal 30 will be described, representing the user terminal. However, a user terminal other than the user terminal 30 is also capable of executing an operation similar to that of the user terminal 30.

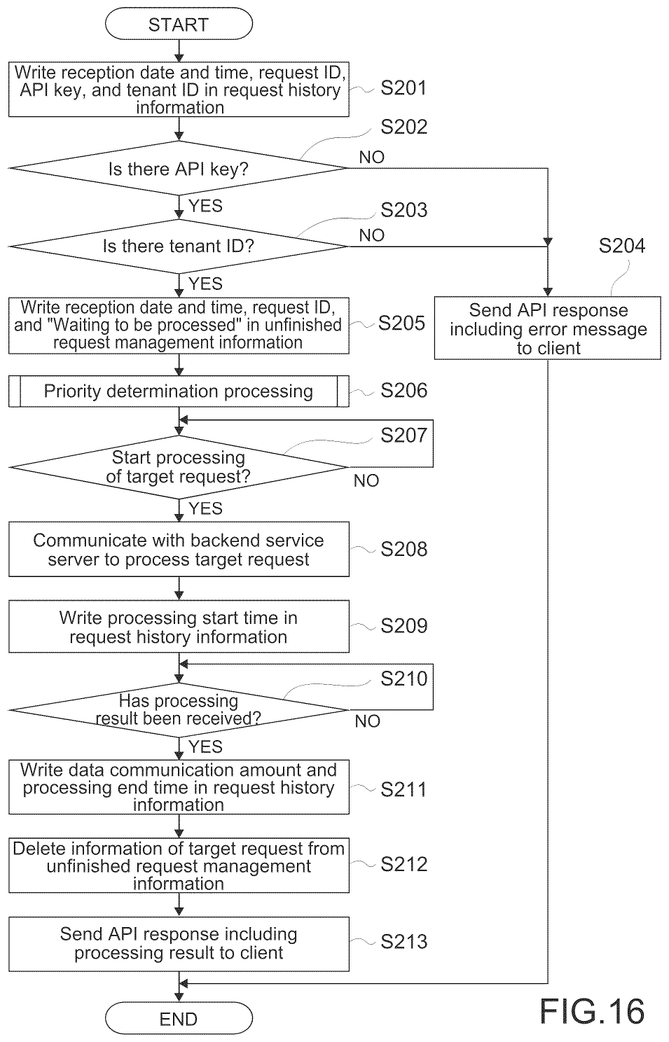

FIG. 16 is a flowchart of the operation of the service providing system 20 in a case of receiving the API request from the client 35a.

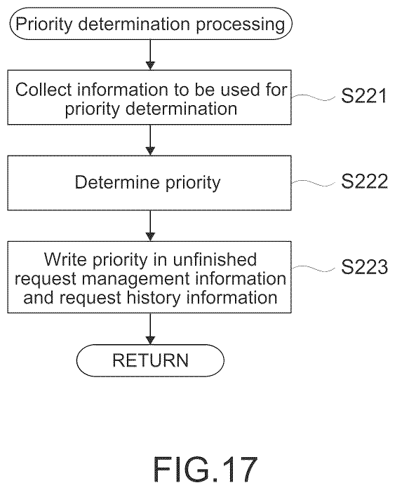

In a case of using the API provided by the service providing system 20, the client 35a sends to the service providing system 20 an API request which has been assigned an API key of the client 35a, which is a request source of the API request, and a tenant ID of the tenant, which is a request destination of the API request. When the service providing system 20 receives the API request, the service providing system 20 executes the operation shown in FIG. 16. Hereinafter, the API request that has caused the service providing system 20 to start the operation shown in FIG. 16 will be referred to as “target request” in the description of the operation shown in FIGS. 16 and 17.

As shown in FIG. 16, the data sending/receiving unit 25m of the service providing system 20 writes reception date and time of the target request by the data sending/receiving unit 25m, a request ID which has been assigned to the target request by the data sending/receiving unit 25m, and API key and tenant ID of the target request in the request history information 24e (S201).

When the processing of S201 ends, the data sending/receiving unit 25m determines whether or not there is an API key assigned to the target request in the client management information 24h (S202).

When the data sending/receiving unit 25m determines in S202 that there is an API key assigned to the target request in the client management information 24h, the data sending/receiving unit 25m determines whether or not there is a tenant ID assigned to the target request in the tenant management information 24i (S203).

When the data sending/receiving unit 25m determines in S202 that there is no API key assigned to the target request in the client management information 24h or when the data sending/receiving unit 25m determines in S203 that there is no tenant ID assigned to the target request in the tenant management information 24i, the data sending/receiving unit 25m sends an API response including an error message indicating that the target request is not a regular API request to the client 35a (S204), and terminates the operation shown in FIG. 16.

When the data sending/receiving unit 25m determines in S203 that there is a tenant ID assigned to the target request in the tenant management information 24i, the priority processing unit 25o writes the reception date and time of the target request by the data sending/receiving unit 25m, the request ID of the target request, and “waiting to be processed,” which is a processing status of the target request, in the unfinished request management information 24j (S205).

When the processing of S205 ends, the priority management unit 25p executes priority determination processing of determining the priority of the target request (S206).

FIG. 17 is a flowchart of the priority determination processing shown in FIG. 16.

When the processing of S205 (see FIG. 16) ends, the priority management unit 25p requests priority determination of the target request from the priority management unit 25p. When the priority management unit 25p is requested to determine the priority of the target request, the priority management unit 25p executes the operation shown in FIG. 17.

As shown in FIG. 17, the priority management unit 25p collects information to be used to determine the priority of the target request (S221).

As the information collected in S221, for example, the API key of the target request may be included.

As the information collected in S221, for example, the tenant ID of the target request may be included.

As the information collected in S221, the amount of use of the API (hereinafter, referred to as “API use amount”) by a specific use source of an API may be included. Here, the use source of the API is any one of the client that is the request source of the API request, the tenant that is the request destination of the API request, or a combination of the client and the tenant.

As the API use amount collected in S221, for example, the number of times a specified API request has been received in the past specific period starting from the current date and time (hereinafter, referred to as “number of request times”) may be included. Here, the specified API request may be any one of an API request which has been assigned a combination of the API key and the tenant ID identical to the combination of the API key and the tenant ID assigned to the target request, an API request which has been assigned an API key identical to the API key assigned to the target request, or an API request which has been assigned a tenant ID identical to the tenant ID assigned to the target request. The priority management unit 25p is capable of acquiring the number of request times from the use status analysis unit 25h. The use status analysis unit 25h is capable of analyzing the number of request times on the basis of the request history information 24e.

As the API use amount collected in S221, for example, the total communication amount of data in the processing of the specified API request in the past specific period starting from the current date and time (hereinafter, referred to as “total data communication amount”) may be included. Here, the specified API request may be any one of the API request which has been assigned the combination of the API key and the tenant ID identical to the combination of the API key and the tenant ID assigned to the target request, the API request which has been assigned the API key identical to the API key assigned to the target request, or the API request which has been assigned the tenant ID identical to the tenant ID assigned to the target request. The priority management unit 25p is capable of acquiring the total data communication amount from the use status analysis unit 25h. The use status analysis unit 25h is capable of analyzing the total data communication amount on the basis of the request history information 24e.

As the API use amount collected in S221, for example, a communication amount obtained by dividing the total data communication amount of the specified API request by the number of request times of the specified API request (hereinafter, referred to as “average data communication amount”) may be included. Here, the specified API request may be any one of the API request which has been assigned the combination of the API key and the tenant ID identical to the combination of the API key and the tenant ID assigned to the target request, the API request which has been assigned the API key identical to the API key assigned to the target request, or the API request which has been assigned the tenant ID identical to the tenant ID assigned to the target request. The priority management unit 25p is capable of acquiring the average data communication amount from the use status analysis unit 25h. The use status analysis unit 25h is capable of analyzing the average data communication amount on the basis of the request history information 24e.

As the API use amount collected in S221, for example, a total processing time of the specified API request by the backend service server 25j in the past specific period starting from the current date and time (hereinafter, referred to as “total processing time”) may be included. Here, the specified API request may be any one of the API request which has been assigned the combination of the API key and the tenant ID identical to the combination of the API key and the tenant ID assigned to the target request, the API request which has been assigned the API key identical to the API key assigned to the target request, or the API request which has been assigned the tenant ID identical to the tenant ID assigned to the target request. The priority management unit 25p is capable of acquiring the total processing time from the use status analysis unit 25h. The use status analysis unit 25h is capable of analyzing the total processing time on the basis of the request history information 24e. The use status analysis unit 25h is capable of setting a time from the start time of the processing of the API request by the backend service server 25j to the end time of the processing of the API request by the backend service server 25j as a processing time of the API request by the backend service server 25j.

As the API use amount collected in S221, for example, a processing time (hereinafter, referred to as “average processing time”) obtained by dividing the total processing time of the specified API request by the number of request times of the specified API request may be included. Here, the specified API request may be any one of the API request which has been assigned the combination of the API key and the tenant ID identical to the combination of the API key and the tenant ID assigned to the target request, the API request which has been assigned the API key identical to the API key assigned to the target request, or the API request which has been assigned the tenant ID identical to the tenant ID assigned to the target request. The priority management unit 25p is capable of acquiring the average processing time from the use status analysis unit 25h. The use status analysis unit 25h is capable of analyzing the average processing time on the basis of the request history information 24e.

In S221, the priority management unit 25p may collect, for each time zone, at least one of the number of request times, the total data communication amount, the average data communication amount, the total processing time, or the average processing time. For example, various zones, such as the time zone of 10:00 AM to 5:00 PM and the time zone of 5:00 PM to 10:00 AM, can be employed as the time zone.

When the processing of S221 ends, the priority management unit 25p determines the priority of the target request on the basis of the information collected in S221 and the priority determination rule indicated by the priority determination rule information 24f (S222).

As the priority determination rule, for example, a rule that determines the priority of the target request as a high priority in a case where a numeric value for evaluating the priority (hereinafter, referred to as “evaluation value”) is calculated on the basis of the information collected in S221 and where the evaluation value is greater than or equal to a specific numeric value and that determines the priority of the target request as a low priority in a case where the evaluation value is less than the specific numeric value may be employed.

As the priority determination rule, a rule that adds a numeric value according to the API key of the target request to the evaluation value may be employed. As the priority determination rule, a rule that determines the priority of the target request as a high priority may be employed in a case where the API key of the target request is a specific API key.

As the priority determination rule, a rule that adds a numeric value according to the tenant ID of the target request to the evaluation value may be employed. As the priority determination rule, a rule that determines the priority of the target request as a high priority may be employed in a case where the tenant ID of the target request is a specific tenant ID.

As the priority determination rule, a rule that is more likely to determine the priority of the target request as a high priority as compared to a case where the number of request times is greater than or equal to a specific number of times, in a case where the number of request times is less than the specific number of times, may be employed. As the priority determination rule, a rule that adds a numeric value according to the number of request times to the evaluation value may be employed. For example, as the priority determination rule, a rule that adds a larger numeric value to the evaluation value as compared to a case where the number of request times is greater than or equal to the specific number of times, in a case where the number of request times is less than the specific number of times, may be employed. As the priority determination rule, a rule that determines the priority of the target request as a high priority in a case where the number of request times is less than the specific number of times and that determines the priority of the target request as a low priority in a case where the number of request times is greater than or equal to the specific number of times may be employed.

As the priority determination rule, a rule that is more likely to determine the priority of the target request as a high priority as compared to a case where the total data communication amount is greater than or equal to a specific communication amount, in a case where the total data communication amount is less than the specific communication amount, may be employed. As the priority determination rule, a rule that adds a numeric value according to the total data communication amount to the evaluation value may be employed. For example, as the priority determination rule, a rule that adds a larger numeric value as the evaluation value as compared to a case where the total data communication amount is greater than or equal to the specific communication amount, in a case where the total data communication amount is less than the specific communication amount, may be employed. As the priority determination rule, a rule that determines the priority of the target request as a high priority in a case where the total data communication amount is less than the specific communication amount and that determines the priority of the target request as a low priority in a case where the total data communication amount is greater than or equal to the specific communication amount may be employed.

As the priority determination rule, a rule that is more likely to determine the priority of the target request as a high priority as compared to a case where the average data communication amount is greater than or equal to a specific communication amount, in a case where the average data communication amount is less than the specific communication amount, may be employed. As the priority determination rule, a rule that adds a numeric value according to the average data communication amount to the evaluation value may be employed. For example, as the priority determination rule, a rule that adds a larger numeric value as the evaluation value as compared to a case where the average data communication amount is greater than or equal to the specific communication amount, in a case where the average data communication amount is less than the specific communication amount, may be employed. As the priority determination rule, a rule that determines the priority of the target request as a high priority in a case where the average data communication amount is less than the specific communication amount and that determines the priority of the target request as a low priority in a case where the average data communication amount is greater than or equal to the specific communication amount may be employed.

As the priority determination rule, a rule that is more likely to determine the priority of the target request as a high priority as compared to a case where the total processing time is a certain time or more, in a case where the total processing time is less than the certain time, may be employed. As the priority determination rule, a rule that adds a numeric value according to the total processing time to the evaluation value may be employed. For example, as the priority determination rule, a rule that adds a larger numeric value as the evaluation value as compared to a case where the total processing time is the certain time or more, in a case where the total processing time is less than the certain time, may be employed. As the priority determination rule, a rule that determines the priority of the target request as a high priority in a case where the total processing time is less than the certain time and that determines the priority of the target request as a low priority that in a case where the total processing time is the certain time or more may be employed.

As the priority determination rule, a rule that is more likely to determine the priority of the target request as a high priority as compared to a case where the average processing time is a certain time or more, in a case where the average processing time is less than the certain time, may be employed. As the priority determination rule, a rule that adds a numeric value according to the average processing time to the evaluation value may be employed. For example, as the priority determination rule, a rule that adds a larger numeric value as the evaluation value as compared to a case where the average processing time is the certain time or more, in a case where the average processing time is less than the certain time, may be employed. As the priority determination rule, a rule that determines the priority of the target request as a high priority in a case where the average processing time is less than the certain time and that determines the priority of the target request as a low priority in a case where the average processing time is the certain time or more may be employed.

As the priority determination rule, a rule that is more likely to determine the priority of the target request as a high priority as compared to a case where the number of request times in the certain time zone is greater than or equal to a specific number of times, in a case where the number of request times in the certain time zone is less than the specific number of times, may be employed. As the priority determination rule, a rule that adds a numeric value according to the number of request times in the certain time zone to the evaluation value may be employed. For example, as the priority determination rule, a rule that adds a larger numeric value as the evaluation value as compared to a case where the number of request times in the certain time zone is greater than or equal to the specific number of times, in a case where the number of request times in the certain time zone is less than the specific number of times, may be employed. As the priority determination rule, a rule that determines the priority of the target request as a high priority in a case where the number of request times in the certain time zone is less than the specific number of times and that determines the priority of the target request as a low priority in a case where the number of request times in the certain time zone is greater than or equal to the specific number of times may be employed.

As the priority determination rule, a rule that is more likely to determine the priority of the target request as a high priority as compared to a case where the total data communication amount in the certain time zone is greater than or equal to a specific communication amount, in a case where the total data communication amount in the certain time zone is less than the specific communication amount, may be employed. As the priority determination rule, a rule that adds a numeric value according to the total data communication amount in the certain time zone to the evaluation value may be employed. For example, as the priority determination rule, a rule that adds a larger numeric value as the evaluation value as compared to a case where the total data communication amount in the certain time zone is greater than or equal to the specific communication amount, in a case where the total data communication amount in the certain time zone is less than the specific communication amount, may be employed. As the priority determination rule, a rule that determines the priority of the target request as a high priority in a case where the total data communication amount in the certain time zone is less than the specific communication amount and that determines the priority of the target request as a low priority in a case where the total data communication amount in the certain time zone is greater than or equal to the specific communication amount may be employed.

As the priority determination rule, a rule that is more likely to determine the priority of the target request as a high priority as compared to a case where an average data communication amount in the certain time zone is greater than or equal to a specific communication amount, in a case where the average data communication amount in the certain time zone is less than the specific communication amount, may be employed. As the priority determination rule, a rule that adds a numeric value according to the average data communication amount in the certain time zone to the evaluation value may be employed. For example, as the priority determination rule, a rule that adds a larger numeric value as the evaluation value as compared to a case where the average data communication amount in the certain time zone is greater than or equal to the specific communication amount, in a case where the average data communication amount in the certain time zone is less than the specific communication amount, may be employed. As the priority determination rule, a rule that determines the priority of the target request as a high priority in a case where the average data communication amount in the certain time zone is less than the specific communication amount and that determines the priority of the target request as a low priority in a case where the average data communication amount in the certain time zone is greater than or equal to the specific communication amount may be employed.

As the priority determination rule, a rule that is more likely to determine the priority of the target request as a high priority as compared to a case where a total processing time in the certain time zone is a certain time or more, in a case where the total processing time in the certain time zone is less than the certain time, may be employed. As the priority determination rule, a rule that adds a numeric value according to the total processing time in the certain time zone to the evaluation value may be employed. For example, as the priority determination rule, a rule that adds a larger numeric value as the evaluation value as compared to a case where the total processing time in the certain time zone is the certain time or more, in a case where the total processing time in the certain time zone is less than the certain time, may be employed. As the priority determination rule, a rule that determines the priority of the target request as a high priority in a case where the total processing time in the certain time zone is less than the certain time and that determines the priority of the target request as a low priority in a case where the total processing time in the certain time zone is the certain time or more may be employed.

As the priority determination rule, a rule that is more likely to determine the priority of the target request as a high priority as compared to a case where an average processing time in the certain time zone is a certain time or more in a case where the average processing time in the certain time zone is less than the certain time may be employed. As the priority determination rule, a rule that adds a numeric value according to the average processing time in the certain time zone to the evaluation value may be employed. For example, as the priority determination rule, a rule that adds a larger numeric value as the evaluation value as compared to a case where the average processing time in the certain time zone is the certain time or more, in a case where the average processing time in the certain time zone is less than the certain time, may be employed. As the priority determination rule, a rule that determines the priority of the target request as a high priority in a case where the average processing time in the certain time zone is less than the certain time and that determines the priority of the target request as a low priority in a case where the average processing time in the certain time zone is the certain time or more may be employed.

When the processing of S222 ends, the priority management unit 25p writes the priority of the target request determined in S222 in the unfinished request management information 24j and the request history information 24e (S223), and terminates the priority determination processing shown in FIG. 17.

As shown in FIG. 16, when the priority determination processing of S206 ends, the priority processing unit 25o determines whether or not to start the processing of the target request until the priority processing unit 25o determines to start the processing of the target request (S207).

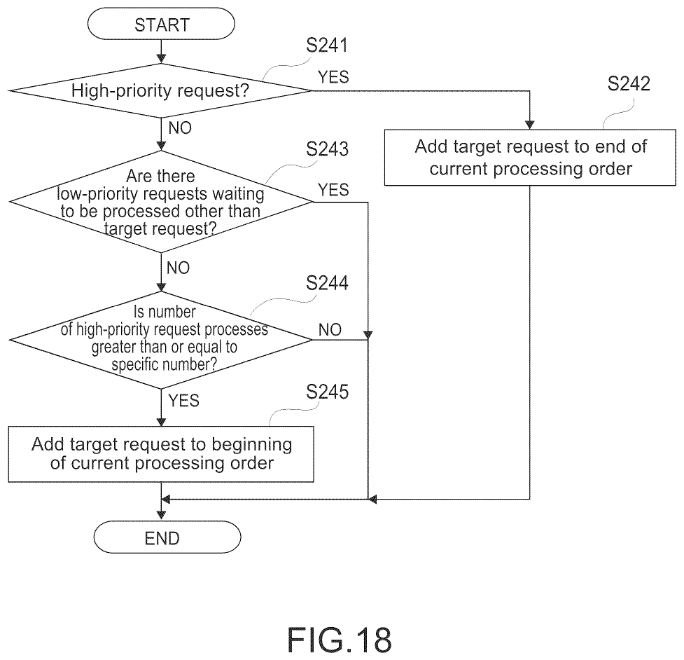

FIG. 18 is a flowchart of an operation of the service providing system 20 when a priority is written in the unfinished request management information 24j in a case where the first priority processing rule is indicated by the priority processing rule information 24g.

The priority processing unit 25o executes the operation shown in FIG. 18 when the priority is written in the unfinished request management information 24j in S223 (see FIG. 17) in a case where the first priority processing rule is indicated by the priority processing rule information 24g.

As shown in FIG. 18, the priority processing unit 25o determines whether or not the API request whose priority is written in the unfinished request management information 24j (hereinafter, referred to as “target request” in the description of the operation shown in FIG. 18) is a high-priority request (S241).

When the priority processing unit 25o determines in S241 that the target request is the high-priority request, the priority processing unit 25o adds the target request to the end of the current processing order in the unfinished request management information 24j (S242). That is, in a case where the processing order is not written in the unfinished request management information 24j, the priority processing unit 25o writes number one in the unfinished request management information 24j as a processing order of the target request. Moreover, in a case where the processing order is written in the unfinished request management information 24j, the priority processing unit 25o writes a processing order immediately following the last processing order of the processing order currently written in the unfinished request management information 24j, in the unfinished request management information 24j as a processing order of the target request.

When the priority processing unit 25o determines in S241 that the target request is not the high-priority request, the priority processing unit 25o determines whether or not there are low-priority requests waiting to be processed other than the target request on the basis of the unfinished request management information 24j (S243).

When the priority processing unit 25o determines in S243 that there are no low-priority requests waiting to be processed other than the target request, the priority processing unit 25o determines whether or not the number of high-priority requests processed after the processing of the previous low-priority request (hereinafter, referred to as “number of high-priority request processes”) is greater than or equal to a specific number (S244). Here, the priority processing unit 25o is capable of calculating the request history information 24e on the basis of the number of high-priority request processes.

When the priority processing unit 25o determines in S244 that the number of high-priority request processes is greater than or equal to the specific number, the priority processing unit 25o adds the target request to the beginning of the current processing order in the unfinished request management information 24j (S245). That is, in a case where the processing order of the high-priority request is not written in the unfinished request management information 24j, the priority processing unit 25o writes number one in the unfinished request management information 24j as a processing order of the target request. Moreover, in a case where the processing order of the high-priority request is written in the unfinished request management information 24j, the priority processing unit 25o shifts the processing order of the high-priority request written in the unfinished request management information 24j down by one, and then writes number one in the unfinished request management information 24j as a processing order of the target request.

When the processing of S242 ends, when the priority processing unit 25o determines in S243 that there are low-priority requests waiting to be processed other than the target request, when the priority processing unit 25o determines in S244 that the number of high-priority request processes is not greater than or equal to the specific number, or when the priority processing unit 25o executes the processing of S245, the priority processing unit 25o terminates the operation shown in FIG. 18.

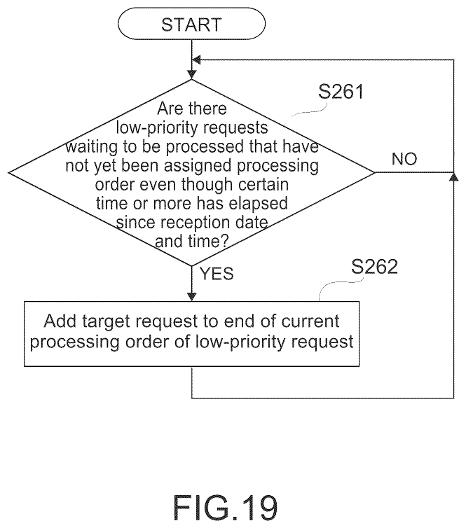

FIG. 19 is a flowchart of an operation of the service providing system 20 when the processing order of the low-priority request is written in the unfinished request management information 24j in a case where the first priority processing rule is indicated by the priority processing rule information 24g.

The priority processing unit 25o executes the operation shown in FIG. 19 in a case where the first priority processing rule is indicated by the priority processing rule information 24g.

As shown in FIG. 19, the priority processing unit 25o determines whether or not there are low-priority requests waiting to be processed, which have not yet been assigned a processing order even though a certain time or more has elapsed since the reception date and time, in the unfinished request management information 24j until the priority processing unit 25o determines that there are low-priority requests waiting to be processed, which have not yet been assigned a processing order even though the certain time or more has elapsed since the reception date and time, in the unfinished request management information 24j (S261).

When the priority processing unit 25o determines in S261 that there are low-priority requests waiting to be processed, which have not yet been assigned a processing order even though the certain time or more has elapsed since the reception date and time, in the unfinished request management information 24j, the priority processing unit 25o adds a low-priority request with the earliest reception date and time (hereinafter, referred to as “target request” in the description in FIG. 19) among the low-priority requests waiting to be processed, which have not yet been assigned a processing order even though the certain time or more has elapsed since the reception date and time, which are in the unfinished request management information 24j, to the end of the current processing order of the low-priority request (S262). That is, in a case where the processing order of the low-priority request is not written in the unfinished request management information 24j and the processing order of the high-priority request is also not written in the unfinished request management information 24j, the priority processing unit 25o writes number one in the unfinished request management information 24j as a processing order of the target request. Moreover, in a case where the processing order of the low-priority request is not written in the unfinished request management information 24j and the processing order of the high-priority request is written in the unfinished request management information 24j, the priority processing unit 25o shifts the processing order of the high-priority request written in the unfinished request management information 24j down by one, and then writes number one in the unfinished request management information 24j as a processing order of the target request. Moreover, in a case where the processing order of the low-priority request is written in the unfinished request management information 24j and the processing order of the high-priority request is not written in the unfinished request management information 24j, the priority processing unit 25o writes a processing order immediately following the last processing order of the processing order currently written in the unfinished request management information 24j, in the unfinished request management information 24j as a processing order of the target request. Moreover, in a case where the processing order of the low-priority request is written in the unfinished request management information 24j and the processing order of the high-priority request is also written in the unfinished request management information 24j, the priority processing unit 25o shifts the processing order of the high-priority request written in the unfinished request management information 24j down by one, and then writes a processing order immediately following the last processing order of the processing order of the low-priority request currently written in the unfinished request management information 24j, in the unfinished request management information 24j as a processing order of the target request.

When the processing of S262 ends, the priority processing unit 25o executes the processing of S261.

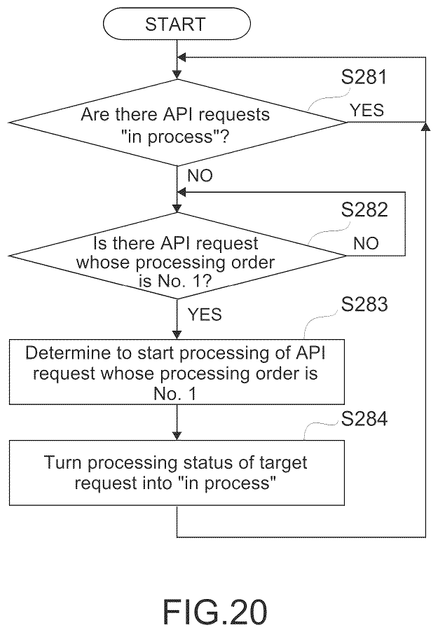

FIG. 20 is a flowchart of an operation of the service providing system 20 when determining to start the processing of the API request in a case where the first priority processing rule is indicated by the priority processing rule information 24g.

In a case where the first priority processing rule is indicated by the priority processing rule information 24g, the priority processing unit 25o executes the operation shown in FIG. 20.

As shown in FIG. 20, the priority processing unit 25o determines whether or not there are API requests whose processing status is “in process” on the basis of the unfinished request management information 24j until the priority processing unit 25o determines that there are no API requests whose processing status is “in process” (S281).

When the priority processing unit 25o determines in S281 that there are no API requests whose processing status is “in process,” the priority processing unit 25o determines whether or not there is an API request whose processing order is number one in the unfinished request management information 24j until the priority processing unit 25o determines that there is an API request whose processing order is number one in the unfinished request management information 24j (S282).

When the priority processing unit 25o determines in S282 that there is an API request whose processing order is number one in the unfinished request management information 24j, the priority processing unit 25o determines to start the processing of the API request whose processing order is number one (hereinafter, referred to as “target request” in the description of the processing shown in FIG. 20), which is in the unfinished request management information 24j (S283).

When the processing of S283 ends, the priority processing unit 25o turns the processing status of the target request with respect to which the priority processing unit 25o has determined in S283 to start the processing into “in process” in the unfinished request management information 24j (S284). Therefore, the priority processing unit 25o deletes the processing order of the target request, and then shifts the processing order of the API request which has been assigned the processing order, which is in the unfinished request management information 24j, up by one.

When the processing of S284 ends, the priority processing unit 25o executes the processing of S281.

As shown in FIG. 16, when the priority processing unit 25o determines in S207 to start the processing of the target request, the request execution unit 25n communicates with the backend service server 25j in order to process the target request (S208).

When the processing of S208 ends, the request execution unit 25n writes the start time of the processing of the target request by the backend service server 25j in the request history information 24e (S209).

When the processing of S209 ends, the request execution unit 25n determines whether or not the request execution unit 25n has received a result of the processing of the target request by the backend service server 25j until the request execution unit 25n determines that the request execution unit 25n has received the result of the processing of the target request by the backend service server 25j (S210).

When the request execution unit 25n determines in S210 that the request execution unit 25n has received the result of the processing of the target request by the backend service server 25j, the priority processing unit 25o writes the communication amount of data in the processing of the target request by the backend service server 25j and the end time of the processing of the target request by the backend service server 25j in the request history information 24e (S211).

When the processing of S211 ends, the priority processing unit 25o deletes the information of the target request from the unfinished request management information 24j (S212).

When the processing of S212 ends, the data sending/receiving unit 25m sends an API response including the result of the processing of the target request by the backend service server 25j to the client (S213), and terminates the operation shown in FIG. 16.

Hereinabove, the case where the first priority processing rule is indicated by the priority processing rule information 24g has been described. Hereinafter, a case where the second priority processing rule is indicated by the priority processing rule information 24g will be described.

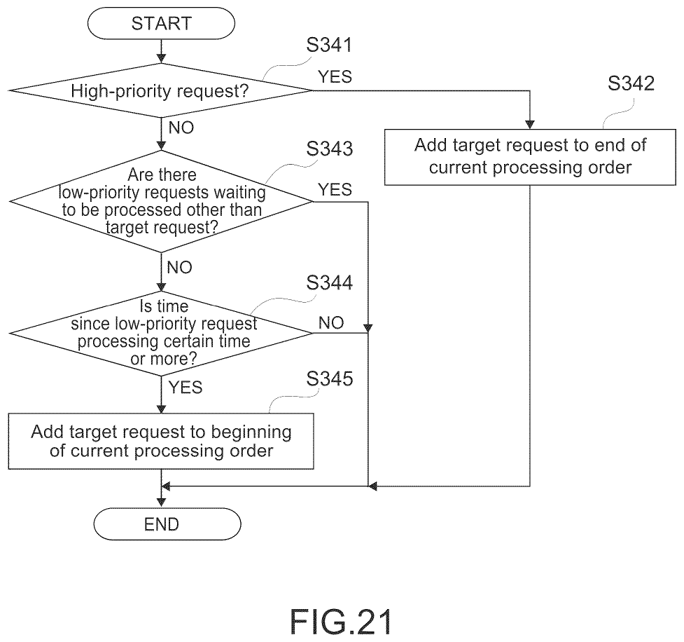

In a case where the second priority processing rule is indicated by the priority processing rule information 24g, the service providing system 20 executes an operation shown in FIG. 21 described below instead of the operation shown in FIG. 18. In a case where the second priority processing rule is indicated by the priority processing rule information 24g, the service providing system 20 executes an operation similar to the operation shown in FIGS. 19 and 20.

FIG. 21 is a flowchart of an operation of the service providing system 20 when the priority is written in the unfinished request management information 24j in a case where the second priority processing rule is indicated by the priority processing rule information 24g.

In a case where the second priority processing rule is indicated by the priority processing rule information 24g, the priority processing unit 25o executes the operation shown in FIG. 21 when the priority is written in the unfinished request management information 24j in S223 (see FIG. 17).

As shown in FIG. 21, the priority processing unit 25o determines whether or not the API request whose priority is written in the unfinished request management information 24j (hereinafter, “target request” referred to as in the description of the operation shown in FIG. 21) is a high-priority request (S341).

When the priority processing unit 25o determines in S341 that the target request is the high-priority request, the priority processing unit 25o adds the target request to the end of the current processing order in the unfinished request management information 24j as in the processing of S242 (S342).

When the priority processing unit 25o determines in S341 that the target request is not the high-priority request, the priority processing unit 25o determines whether or not there are low-priority requests waiting to be processed other than the target request on the basis of the unfinished request management information 24j (S343).

When the priority processing unit 25o determines in S343 that there are no low-priority requests waiting to be processed other than the target request, the priority processing unit 25o determines whether or not a time that has elapsed since the processing of the previous low-priority request (hereinafter, referred to as “time since the low-priority request processing”) is a certain time or more (S344). Here, the priority processing unit 25o is capable of calculating the time since the low-priority request processing on the basis of the request history information 24e. The certain time in S344 may be longer than the certain time in S261 (see FIG. 19).

When the priority processing unit 25o determines in S344 that the time since the low-priority request processing is the certain time or more, the priority processing unit 25o adds the target request to the beginning of the current processing order in the unfinished request management information 24j as in the processing of S245 (S345).

When the processing of S342 ends, when the priority processing unit 25o determines in S343 that there are low-priority requests waiting to be processed other than the target request, when the priority processing unit 25o determines in S344 that the time since the low-priority request processing is not the certain time or more, or when the priority processing unit 25o executes the processing of S345, the priority processing unit 25o terminates the operation shown in FIG. 21.

Hereinabove, the case where the first priority processing rule or the second priority processing rule is indicated by the priority processing rule information 24g has been described. Hereinafter, a case where the third priority processing rule is indicated by the priority processing rule information 24g will be described.

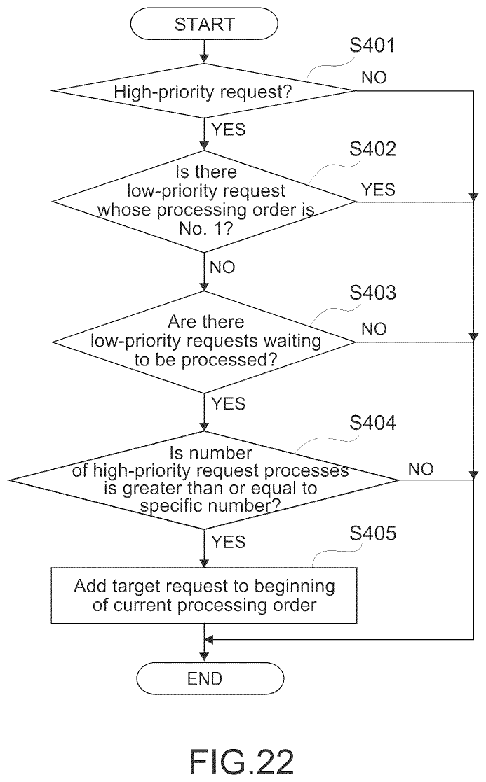

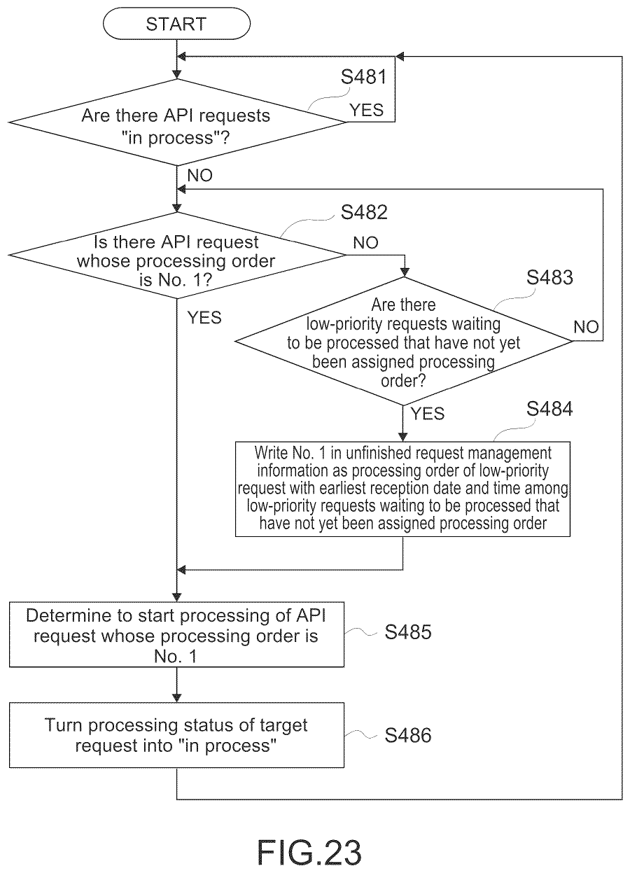

In a case where the third priority processing rule is indicated by the priority processing rule information 24g, the service providing system 20 executes an operation similar to the operation shown in FIGS. 18 and 19. In a case where the third priority processing rule is indicated by the priority processing rule information 24g, the service providing system 20 executes an operation shown in FIGS. 22 and 23 described below in addition to the operation shown in FIGS. 18 and 19.

FIG. 22 is a flowchart of an operation of the service providing system 20 when the API interface unit 25k receives the result of the processing of the API request from the backend service server 25j in a case where the third priority processing rule is indicated by the priority processing rule information 24g.

In a case where the third priority processing rule is indicated by the priority processing rule information 24g, the priority processing unit 25o executes the operation shown in FIG. 22 every time the processing of S211 (see FIG. 16) ends.

As shown in FIG. 22, the priority processing unit 25o determines whether or not the API request with respect to which the end time of the processing was most recently written in the request history information 24e is a high-priority request (S401).

When the priority processing unit 25o determines in S401 that the API request with respect to which the end time of the processing was most recently written in the request history information 24e is the high-priority request, the priority processing unit 25o determines whether or not there is a low-priority request whose processing order is number one on the basis of the unfinished request management information 24j (S402).

When the priority processing unit 25o determines in S402 that there is no low-priority request whose processing order is number one, the priority processing unit 25o determines whether or not there are low-priority requests waiting to be processed on the basis of the unfinished request management information 24j (S403).

When the priority processing unit 25o determines in S403 that there are low-priority requests waiting to be processed, the priority processing unit 25o determines whether or not the number of high-priority request processes is greater than or equal to a specific number (S404). Here, the priority processing unit 25o is capable of calculating the request history information 24e on the basis of the number of high-priority request processes. The specific number in S404 is identical to the specific number in S244.

When the priority processing unit 25o determines in S404 that the number of high-priority request processes is greater than or equal to the specific number, the priority processing unit 25o adds the low-priority request with the earliest reception date and time (hereinafter, referred to as “target request” in the description of the operation shown in FIG. 22) among the low-priority requests waiting to be processed, to the beginning of the current processing order in the unfinished request management information 24j (S405). That is, in a case where the processing order of the high-priority request is not written in the unfinished request management information 24j, the priority processing unit 25o writes number one in the unfinished request management information 24j as a processing order of the target request. Moreover, in a case where the processing order of the high-priority request is written in the unfinished request management information 24j, the priority processing unit 25o shifts the processing order of the high-priority request written in the unfinished request management information 24j down by one, and then writes number one in the unfinished request management information 24j as a processing order of the target request.

When the priority processing unit 25o determines in S401 that the API request with respect to which the end time of the processing was most recently written in the request history information 24e is not the high-priority request, when the priority processing unit 25o determines in S402 that there is a low-priority request whose processing order is number one, when the priority processing unit 25o determines in S403 that there are no low-priority requests waiting to be processed, when the priority processing unit 25o determines in S404 that the number of high-priority request processes is not greater than or equal to the specific number, or when the processing of S405 ends, the priority processing unit 25o terminates the operation shown in FIG. 22.

FIG. 23 is a flowchart of an operation of the service providing system 20 when determining to start the processing of the API request in a case where the third priority processing rule is indicated by the priority processing rule information 24g.

In a case where the third priority processing rule is indicated by the priority processing rule information 24g, the priority processing unit 25o executes the operation shown in FIG. 23.

As shown in FIG. 23, the priority processing unit 25o determines whether or not there are API requests whose processing status is “in process” on the basis of the unfinished request management information 24j until the priority processing unit 25o determines that there are no API requests whose processing status is “in process” (S481).

When the priority processing unit 25o determines in S481 that there are no API requests whose processing status is “in process,” the priority processing unit 25o determines whether or not there is an API request whose processing order is number one in the unfinished request management information 24j (S482).

When the priority processing unit 25o determines in S482 that there is no API request whose processing order is number one in the unfinished request management information 24j, the priority processing unit 25o determines whether or not there are low-priority requests waiting to be processed in the unfinished request management information 24j, which have not yet been assigned a processing order (S483).

When the priority processing unit 25o determines in S483 that there are no low-priority requests waiting to be processed, which have not yet been assigned a processing order, in the unfinished request management information 24j, the priority processing unit 25o executes the processing of S482.

When the priority processing unit 25o determines in S483 that the priority processing unit 25o there are low-priority requests waiting to be processed in the unfinished request management information 24j, which have not yet been assigned a processing order, the priority processing unit 25o writes number one in the unfinished request management information 24j as the processing order of the low-priority request with the earliest reception date and time among the low-priority requests waiting to be processed, which have not yet been assigned a processing order, which are in the unfinished request management information 24j (S484).

When the priority processing unit 25o determines in S482 that there is an API request whose processing order is number one in the unfinished request management information 24j or when the processing of S484 ends, the priority processing unit 25o determines to start the processing of the API request whose processing order is number one (hereinafter, referred to as “target request” in the description of the processing shown in FIG. 23), which is in the unfinished request management information 24j (S485).

When the processing of S485 ends, the priority processing unit 25o turns the processing status of the target request with respect to which the priority processing unit 25o has determined in S485 to start the processing into “in process” in the unfinished request management information 24j (S486). Therefore, the priority processing unit 25o deletes the processing order of the target request, and then shifts the processing order of the API request which has been assigned the processing order, which is in the unfinished request management information 24j, up by one.

When the processing of S486 ends, the priority processing unit 25o executes the processing of S481.

As described above, in a case where the service providing system 20 determines the priority of the API request in S222 so that the amount of use of the API by the client that is the request source of the API request becomes smaller as the priority of the API request becomes higher, the service providing system 20 is capable of reducing the possibility that the API request from the specific client occupies the processing resources of the API request. Therefore, the service providing system 20 is capable of enhancing the fairness of the service. In a case where the service providing system 20 determines the priority of the API request in S222 so that the amount of use of the API by the tenant that is the request destination of the API request becomes smaller as the priority of the API request becomes higher, the service providing system 20 is capable of reducing the possibility that the API request to the specific tenant occupies the processing resources of the API request. Therefore, the service providing system 20 is capable of enhancing the fairness of the service.

In a case where the service providing system 20 determines the priority of the specific request in S222 so that the number of times the service providing system 20 receives the API request with respect to which the use source of the API is identical to the use source of a specific request that is the specified API request becomes smaller as the priority of the API request becomes higher, the service providing system 20 is capable of enhancing the appropriateness of the priority of the API request. In a case where the service providing system 20 determines the priority of the specific request in S222 so that the communication amount of data in the processing of the API request with respect to which the use source of the API is identical to the use source of the specific request that is the specified API request becomes smaller as the priority of the API request becomes higher, the service providing system 20 is capable of enhancing the appropriateness of the priority of the API request. In a case where the service providing system 20 determines the priority of the specific request in S222 so that the processing time of the API request with respect to which the use source of the API is identical to the use source of the specific request that is the specified API request becomes smaller as the priority of the API request becomes higher, the service providing system 20 is capable of enhancing the appropriateness of the priority of the API request.

In a case where the service providing system 20 determines the priority of the API request in S222 on the basis of the amount of use of the API in each time zone by the specific use source of the API, the service providing system 20 is capable of reducing the possibility that a use source that tends to use a large amount of processing resources of the API request in the certain time zone occupies the processing resources of the API request. Therefore, the service providing system 20 is capable of enhancing the fairness of the service.

In a case where the service providing system 20 has previously processed a low-priority request that is the API request with the lowest priority among the low-priority requests, and where the service providing system 20 has processed a specific number or more of API requests with a priority higher than the priorities of the low-priority requests (YES in S244 or YES in S404), the service providing system 20 processes one of the low-priority requests (YES in S207, S208, S245, S283, and S405). Therefore, the service providing system 20 is capable of reducing the possibility that the processing delay of the low-priority request excessively increases. As a result, the service providing system 20 is capable of enhancing the fairness of the service.

In a case where the service providing system 20 has previously processed the low-priority request that is the API request with the lowest priority among the low-priority requests, and where the certain time or more has elapsed (YES in S344), the service providing system 20 processes one of the low-priority requests (YES in S207, S208, S283, and S345). Therefore, the service providing system 20 is capable of reducing the possibility that the processing delay of the low-priority request excessively increases. As a result, the service providing system 20 is capable of enhancing the fairness of the service.

In a case where the certain time or more has elapsed (YES in S261) since the service providing system 20 received the low-priority request that is the API request with the lowest priority among the low-priority requests, the service providing system 20 processes this low-priority request (YES in S207, S208, S262, and S283). Therefore, the service providing system 20 is capable of reducing the possibility that the processing delay of the low-priority request excessively increases. As a result, the service providing system 20 is capable of enhancing the fairness of the service.

It should be understood by those skilled in the art that various modifications, combinations, sub-combinations and alterations may occur depending on design requirements and other factors insofar as they are within the scope of the appended claims or the equivalents thereof.

What is claimed is:

1. A service providing system configured to:
execute connection to a micro-service according to a specific request in a case where the service providing system has received the specific request, which is a specific application programming interface (API) request assigned specific identification information, and where the number of times of reception of the API request assigned the specific identification information has not exceeded a specific rate limit, the specific identification information being identification information of a specific client, the specific rate limit being a rate limit associated with the specific identification information; and
update the specific rate limit in accordance with a whole load of all the micro-services that operate in response to the specific request in a case where the service providing system has received the specific request.

2. The service providing system according to claim 1, which is further configured to
increase the specific rate limit in a case where the service providing system has received the specific request and where the load is less than or equal to a specific threshold.

3. The service providing system according to claim 1, which is further configured to
decrease the specific rate limit in a case where the service providing system has received the specific request and where the load is greater than or equal to the specific threshold.

4. The service providing system according to claim 1, which is further configured to
update the specific rate limit to a default limit in a case where current date and time have passed a certain time or more since latest update date and time of the specific rate limit.

5. The service providing system according to claim 1, which is further configured to
send, in a case where the service providing system has received the specific request and where the service providing system has updated the specific rate limit, an API response indicating that the service providing system has updated the specific rate limit to a source of the specific request.

6. The service providing system according to claim 5, which is further configured to
include the updated rate limit associated with the specific identification information in the API response.

7. The service providing system according to claim 1, which is further configured to
include, in a case where the service providing system has received the specific request and the service providing system has updated the specific rate limit, the service providing system having updated the specific rate limit in a webpage associated with the specific identification information.

8. The service providing system according to claim 7, which is further configured to
include the updated rate limit associated with the specific identification information in the webpage.

9. An information processing apparatus configured to:
execute connection to a micro-service according to a specific request in a case where the information processing apparatus has received the specific request, which is a specific application programming interface (API) request assigned specific identification information, and where the number of times of reception of the API request assigned the specific identification information has not exceeded a specific rate limit, the specific identification information being identification information of a specific client, the specific rate limit being a rate limit associated with the specific identification information; and
update the specific rate limit in accordance with a whole load of all the micro-services that operate in response to the specific request in a case where the information processing apparatus has received the specific request.

10. A service providing program that is executed by a computer, which causes the computer to:
execute connection to a micro-service according to a specific request in a case where the computer has received the specific request, which is a specific application programming interface (API) request assigned specific identification information, and where the number of times of reception of the API request assigned the specific identification information by the computer has not exceeded a specific rate limit, the specific identification information being identification information of a specific client, the specific rate limit being a rate limit associated with the specific identification information; and
update the specific rate limit in accordance with a whole load of all the micro-services that operate in response to the specific request in a case where the computer has received the specific request.

11. The service providing system according to claim 1, which is further configured to:
determine a priority so that as the priority of the API request becomes higher, an amount of use of an API by a specific use source of the API becomes smaller; and
preferentially process the API request with the higher priority, wherein
the use source is any one of a client that is a request source of the API request, a tenant that is a request destination of the API request, or a combination of the client and the tenant.

12. The service providing system according to claim 11, wherein
the amount of use in a case where the priority of a specific request that is the API request specified is determined includes at least one of
the number of times the API request with respect to which the use source is identical to the use source of the specific request has been received,
a data communication amount in the processing of the API request with respect to which the use source is identical to the use source of the specific request, or
a processing time of the API request with respect to which the use source is identical to the use source of the specific request.

13. The service providing system according to claim 11, which is further configured to
determine the priority on a basis of the amount of use in each time zone.

14. The service providing system according to claim 11, which is further configured to
process, in a case where the service providing system has previously processed a low-priority request that is the API request with the lowest priority, and where the service providing system has processed a specific number or more of API requests with a priority higher than the priorities of the low-priority requests, one of low-priority requests.

15. The service providing system according to claim 11, which is further configured to
process, in a case where the service providing system has previously processed a low-priority request that is the API request with the lowest priority, and where the certain time or more has elapsed, one of low-priority requests.

16. The service providing system according to claim 11, which is further configured to
process, in a case where the certain time or more has elapsed since the service providing system received a low-priority request that is the API request with the lowest priority, the low-priority request.

17. The information processing apparatus according to claim 9, which is further configured to:
determine a priority so that as the priority of the API request becomes higher, an amount of use of an API by a specific use source of the API becomes smaller; and
preferentially process the API request with the higher priority, wherein
the use source is any one of a client that is a request source of the API request, a tenant that is a request destination of the API request, or a combination of the client and the tenant.

18. The service providing program according to claim 10, which further causes the computer to:
determine a priority so that as the priority of the API request becomes higher, an amount of use of an API by a specific use source of the API becomes smaller; and
preferentially process the API request with the higher priority, wherein
the use source is any one of a client that is a request source of the API request, a tenant that is a request destination of the API request, or a combination of the client and the tenant.
